(19) United States
(12) Patent Application Publication
(10) Pub. No.: US 2002/0122870 A1
(43) Pub. Date: Sep. 5, 2002

(54) Flavor stabilization in foods

(76) Inventors: Christine McBride, Crown Point, IN (US); Helena Qi, Munster, IN (US); Allan Hedges, Crown Point, IN (US)

Correspondence Address: BIERMAN MUSERLIAN AND LUCAS, 600 THIRD AVENUE, NEW YORK, NY, 10016

(21) Appl. No.: 10/023,671

(22) Filed: Dec. 18, 2001

Related U.S. Application Data
(60) Provisional application No. 60/278,851, filed on Mar. 26, 2001.
(60) Provisional application No. 60/257,379, filed on Dec. 21, 2000.

(51) Int. Cl. A23L 1/222

(52) U.S. Cl. 426/651

(57) ABSTRACT

Complexing a flavor with a cyclodextrin and then employing the complex in a food, stabilizes the flavor during frozen storage and during microwave cooking.

### PRIORITY CLAIM

This application claims the priority under 35 USC 119(e) of U.S. Provisional Patent Application Serial Nos. 60/257,379 filed Dec. 21, 2000 and 60/278,851 filed Mar. 26, 2001.

### BACKGROUND OF INVENTION

1. Field of Invention

This invention relates to stabilization of flavors in prepared foods and, more particularly, to the stabilization of flavors in frozen foods and microwave heated foods.

2. Art Related to Invention

The loss of flavor during freezing and storing of food has long been a problem. The freezing process causes a change of the flavor, which diminishes the desirability of frozen food. Flavor chemists have shown that this process is destruction on a molecular level.

Additionally, the microwavable food market has not progressed to optimum market saturation due in part to poor flavor quality. The destruction of flavor that occurs during the microwaving process has inhibited further promotion of microwavable processed food. Microwaving induces very unique heat system whereby flavors are distorted. The intended flavor can be destroyed as well as new flavors developed due to ingredients interacting.

There is a need to improve the stabilization of flavors in prepared foods, especially prepared foods which are frozen and then by microwave for consumption.

### SUMMARY OF INVENTION

It has ben discovered that using cyclodextrin to encapsulate a flavor in a frozen food or a food intended for microwave heating protects the flavor better than other known encapsulating agents. More particularly, it has been found that protecting flavors by encapsulating them with cyclodextrin provides more flavor stability during frozen food storage and/or microwave cooking than other known encapsulating agents. Additionally, it has been found that encapsulation with cyclodextrin also presents fewer off flavors and has been preferred by sensory panelists over other known encapsulating agents in frozen foods and microwave heated foods.

It is both surprising and unexpected that cyclodextrin performs better than other known encapsulating agents in frozen foods and microwave heated foods. Specifically, cyclodextrin has been found to out-perform gum arabic and starches.

Furthermore, using cyclodextrins to encapsulate flavors can reduce the amount of flavor used in a food. The current practice is to overdose the required flavor in frozen foods and microwave heated foods to achieve minimum taste requirements. This is a costly method and the use of cyclodextrin can alleviate this problem by allowing for a reduced amount of flavor to be used in the food.

Broadly, the present invention is characterized as a method for stabilizing flavors in prepared foods comprising:

encapsulating said flavor with a cyclodextrin;

recovering the encapsulated flavor; and

adding the encapsulated flavor to a food during preparation.

Suitably, the cyclodextrin is an alpha, beta or gamma cyclodextrin or a modified alpha, beta or gama cyclodextrin.

Suitably,l the prepared food is a frozen prepared food or a microwavable prepared food. The method of the present invention also protects the flavor during repeated freezing and thawing.

The term prepared food means a food which is formulated by a manufacturer and then sold for consumption. As noted, such prepared food is suitably one that is sold as a frozen food or sold for heating by a microwave oven or a frozen food sold for heating by a microwave oven.

### DETAILED DESCRIPTION OF INVENTION

The flavors are encapsulated in any conventional manner with cyclodextrin. For example, mixing the flavor with cyclodextrin in water and then recovering the complexed flavor (encapsulated flavor). The addition of the cyclodextrin and flavor to the solvent can be done simultaneously or one at a time for precipitation of the complex.

The encapsulated flavor is then added to the food during formulation of the food in a conventional manner and at a conventional time during the formulation, e.g. when the unencapsulated flavor would have been added

The foodstuff with the cyclodextrin encapsulated flavor is then subject to conventional freezing and storage or microwaving.

In encapsulating the flavor with the cyclodextrin, the molar ratio of cyclodextrin:flavor used to encapsulate the flavor is about 0.5:1 to about 5:1 and, more preferably, about 1:1 to about 2:1.

Also, encapsulating the flavor with the cyclodextrin, the amount of cyclodextrin used to encapsulate the flavor is a weight ratio of about 4:1 to about 44:1 based on the weight of cyclodextrin to flavor. More preferably, the weight ratio of cyclodextrin to flavor is about 7:1 to about 10:1. Depending on the flavor or the component intended to be protected, the amount can vary to be much more than or much less than these amounts. The components in the final food product may also effect the amount of cyclodextrin used to encapsulate the flavor.

The cyclodextrins employed in this invention include alpha, beta, gamma as well as modified cyclodextrins. Cyclodextrins are a known product obtained from the conversion of starch with enzymes, CGTase. The cyclodextrins used in the present invention are obtained in a conventional manner.

Cyclodextrins can also be used to protect flavoring in pharmaceutical applications where freezing and/or microwaving is used in the preparation as well as protection of fragrances used in foods and pharmaceutical compounds which are subject to freezing and/or microwaving in their preparations.

To protect fragrances, the fragrance is complexed with the cyclodextrin and the resulting complex is recovered and used in the food or pharmaceutical in a conventional manner.

### BRIEF DESCRIPTION OF DRAWINGS

FIG. 1 illustrates the results from testing a raspberry glaze.

These and other aspects of the present invention may be more fully understood by reference to one or more of the following examples.

### EXAMPLES

### Introduction

The examples given are in two different applications. One application utilizes an encapsulated fruit flavor, raspberry, with both beta cyclodextrin (BCD) and gamma cyclodextrin (GCD) to illustrate the functionality of the various cyclodextrin forms. A second application utilizes an essential oil flavor, onion, to illustrate the versatility of cyclodextrins as flavor protectants in foods, both microwavable and frozen.

### Encapsulation and Determination of Flavor Load Levels

Flavor encapsulation may be performed in any of the established methods of complexation with cyclodextrins. In these examples, encapsulation was achieved by a co-precipitation method followed by spray drying. The flavor load levels in the encapsulated products were determined via solvent extraction-gas chromatography method. These load levels were used to adjust the formulation so that the same amount of flavor was added for each test. The control in these tests was the flavor plated onto a maltodextrin. Gum Arabic, a standard encapsulant widely used in the food industry, was also used. The examples show an improvement when the flavor is encapsulated with cyclodextrin for both frozen and microwavable foods.

The flavor load levels for the raspberry flavor are:

6.7% plated onto maltodextrin

11.8% with beta cyclodextrin

15.5% with gum arabic

19.5% with gamma cyclodextrin

The flavor load levels for onion flavor are:

10.2% plated onto maltodextrin (plated)

10.2% with beta cyclodextrin

b 7.2% with gum arabic

### Sample Preparation

A. Raspberry Glaze Preparation (microwaved)

1. Raspberry Glaze Formulation

| | |
|---|---|
| Ingredients | Amount |

| | | |
|---|---|---|
| Water | 1000 | g |
| Sugar | 120 | g |
| Oetker ™ Glaze Mix | 40 | g |
| Malic Acid | 5 | g |
| Adjusted Flavors added | | |
| Plated maltodextrin | 2.06 | g |
| BCD encapsulated | 1.17 | g |
| GCD encapsulated | 0.71 | g |
| Gum Arabic encapsulated | 0.39 | g |

2. Sample Preparation

1. Dry ingredients were weighed and mixed in 2000 ml beaker.

2. Water was weighed and added in 4 intervals, mixing well after each addition.

3. Samples were cooked in microwave on high in 3 intervals of 6 minutes each for a total of 18 minutes.

4. After each cooking interval, samples were removed from the microwave and stirred.

5. 24 drops of Food Coloring were added to each sample for coloring.

B. Raspberry Ice Milk Preparation

1. Raspberry Ice Milk Formulation

| | |
|---|---|
| Ingredients | Amount |

| | | |
|---|---|---|
| Sweetened Condensed Milk | 540 | g |
| Skim Milk | 540 | g |
| Adjusted flavors added | | |
| Plated maltodextrin | 2.85 | g |
| BCD encapsulated | 1.62 | g |
| Gum Arabic encapsulated | 1.23 | g |

2. Sample Preparation

1. Weigh sweetened condensed milk into a 2000 ml beaker.

2. Add ½ of skim milk to condensed milk and whisked in with a wire whisk.

3. Add flavor and mix with a wire whisk.

4. Add the remainder of skim milk and stir on a stir plate on high for 10 minutes.

5. Ice was frozen in 2 oz. sample cups.

C. Onion Gravy Preparation

1. Onion Gravy Formulation

The same formulation was used for both frozen food and microwavable food samples, except for the gravy mix.

| | |
|---|---|
| Ingredients | Amount |

| | | |
|---|---|---|
| Gravy Mix* | 68.0 | g |
| Water | 750 | g |
| Adjusted Flavor Added | | |
| Plated Flavor | 0.0098 | g |
| BCD encapsulated | 0.0098 | g |
| Gum Arabic encapsulated | 0.0193 | g |

2. Frozen Gravy Sample Preparation

For this sample, the gravy mix was Knorr's Classic Brown Gravy Mix.

1. Gravy mix and water were measured into a 1000 ml beaker.

2. Flavor was weighed on an analytical balance and added to the above mixture.

3. Gravy was mixed for 3 minutes using a wire whisk and metal spatulas to scrape sides.

4. Gravy was heated on stove top for 5 minutes.

5. Gravy was cooled for 30 minutes using wire whisk and metal spatulas to scrape sides.

6. Gravy was capped and frozen overnight.

7. Gravy was removed from freezer 5 hours before testing and placed in a water bath.

8. Water bath temperature was increased 2 levels every hour until samples were defrosted and warm.

9. Gravy was held in a water bath of 150° F. during sensory evaluations.

3. Microwave Gravy Sample Preparation

For this sample, the gravy mix was McCormick Mushroom Gravy Mix

1. Gravy mix and water were measured into a 1000 ml beaker.

2. Flavor was weighed on an analytical balance and added to the above mixture.

3. Gravy was mixed for 3 minutes using a wire whisk and metal spatulas to scrape sides.

4. Gravy was heated in microwave for 5 minutes on high, stirred and heated for additional 5 minutes.

5. Gravy was held in a water batch of 150° F. during sensory evaluations.

### Sensory Procedure

### Sensory Panelist Profile

The sensory panel consisted of personnel trained in sensory evaluation techniques. The panelists were not specialists in any particular flavor or application. The panel ranking and rating results are reported as average scores from a minimum of 20 panelists to a maximum of 26 panelists per session. Preference results and ranking results are reported as a percent of the total panelist participating in the session.

### Triangle Testing

Preliminary triangle testing was done to assure that the panelists could detect a difference between the samples. Triangle tests between cyclodextrin complexed flavors and plated flavors indicated with 99.9% confidence level that the panelists could distinguish a difference.

### Rating and Ranking Testing

Panelists were asked to rate cyclodextrin complexed flavors, gum arabic encapsulated flavors and plated flavors. They rated these treatments on an unscaled line. The least flavor rating possible was established as 1 and the highest flavor rating possible was assigned as 10. They were also asked to rank the intensity of the flavor with 1 as the most flavor and 3 the least flavor. Following rating and ranking, the panelists were asked to identify which sample they preferred.

### Flavor Profile Testing

The panelists were requested in a separate test to profile each flavor treatment independently for several attribute characteristics of the flavor. Again, these profiles are reported as averages.

All sensory evaluations were performed as a blind analysis, with samples assigned a random three-digit number and with the samples rotated for random presentation in accordance with ASTM Committee E18 recommendations

### Results

1. Raspberry Glaze Application—Microwave—BCD

The panelists were presented with the raspberry glazes stabilized to room temperature for raspberry flavor encapsulated with beta cyclodextrin, gum arabic and the control of maltodextrin.

### Raspberry Flavor Rating

Panelists were asked to rate raspberry flavor intensity in the microwaved raspberry glaze on an unscaled line, beginning with 1 and ending with 10. The panelists rated the raspberry flavor encapsulated with various treatments with the following values. Beta cyclodextrin treated flavor rated the highest at 7.82. Gum Arabic treated flavor rated second with a value of 6.68. The control sample that was plated onto a maltodextrin rated the lowest at 4.70 (These are the average of the ratings for all the panelists).

### Raspberry Flavor Ranking

Panelists were asked to rank which treatment had the most flavor, second most and least flavor. Beta cyclodextrin complexed flavor was chosen 69% of the time as having the highest intensity of raspberry flavor, followed by the gum arabic treatment chosen 23% of the time as having the most flavor and the plated flavor chosen 8% as having the most flavor.

### Raspberry Flavor Preference

Panelists were asked to rate their overall preference among the three samples. The panelists were to consider raspberry flavor, sweetness, acidity, balanced flavors and off flavors. The beta cyclodextrin encapsulated sample was preferred by 53% of the panelists. This was followed by gum arabic, 31%, 12% of the panelists had no preference, and 4% for plated.

### Raspberry Glaze Profile

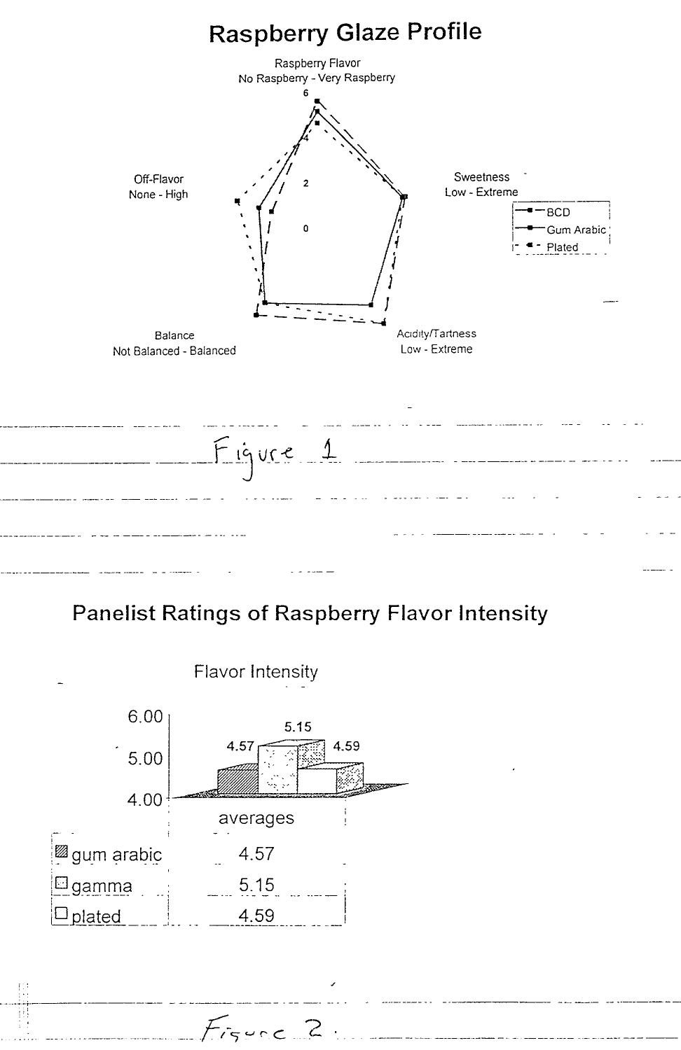

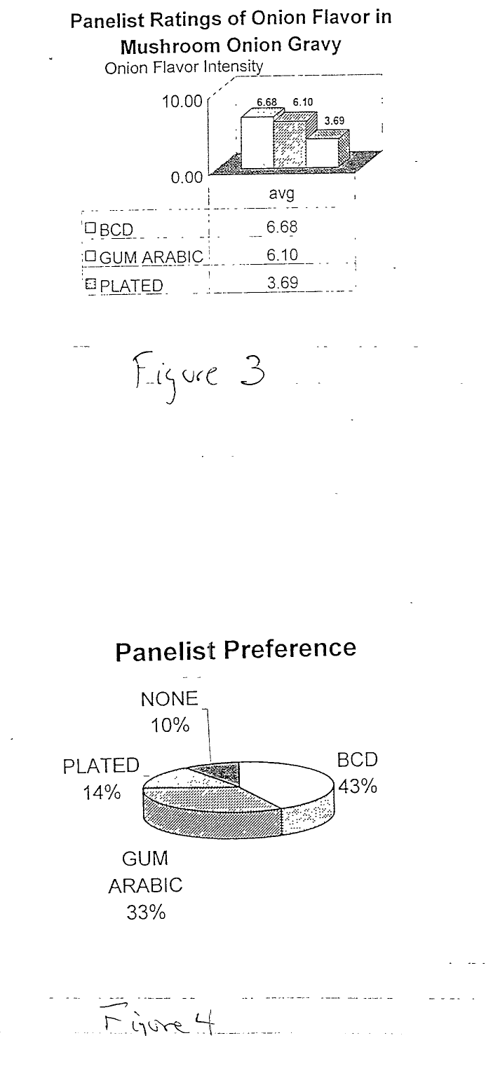

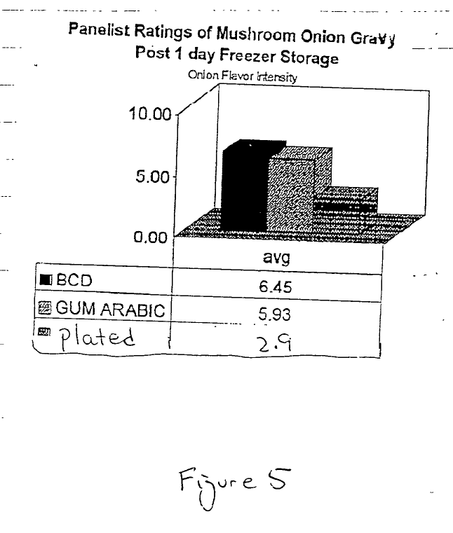

In a separate test, panelists were asked to profile several attributes of raspberry flavor. The accumulation of these attributes provides insight as to why panelists prefer one sample above another. The panelists rated the following attributes for each of the test samples: raspberry flavor intensity, sweetness, off flavors, flavor balance and acidity. The ratings of these attributes are displayed in the radial graph, FIG. 1. The comments from the panelists and the profiles assembled indicate that not only is the flavor intensity protected, but also there are fewer off flavors and a more perceived balanced flavor when the raspberry flavor is complexed with cyclodextrins.

Comments from the panelists about the raspberry glaze were also recorded and are listed below.

### Raspberry Glaze Using Flavor Encapsulated with Beta Cyclodextrin

More raspberry flavor and balance.

Not sweet-bitter taste.

Better taste profile.

Tart/acid.

No off flavors.

### Raspberry Glaze Using Flavor Encapsulated with Gum Arabic

Bitter off flavor.

Tasted artificial.

Sweet/acid overpowers raspberry.

Low flavor.

### Raspberry Glaze Using Flavor Plated onto a Maltodextrin

Tasted artificial.

Tart.

Bitter aftertaste.

Strong off flavor.

Cardboard.

2. Raspberry Glaze Application—Microwave—GCD

The panelists were presented with the raspberry glaze with flavors encapsulated with gamma cyclodextrin, gum arabic and a control with maltodextrin.

### Raspberry Flavor Rating

The panelists were asked to rate the samples for raspberry flavor intensity, rank the flavors as to which had the most, middle or least flavor and to rate the flavor for preference. Using the same 1 to 10 scale as used in the previous rating test, with 10 being the best, the average results of the ratings were 5.15 for GCD, 4.59 for maltodextrin and 4.57 for gum arabic.

### Raspberry Flavor Ranking

When the panel was asked to rank the raspberry flavor intensity, 54% of the panelists ranked the gamma cyclodextrin (GCD) sample as having the most flavor. The flavor encapsulated with gum arabic and the plated flavor were chosen by 29% and 25%, respectively, of the panel as having the most raspberry flavor.

### Flavor Preference

The sample with gamma cyclodextrin was perceived by 37% of the panelists as having the best flavor.

3. Raspberry Ice Milk Application

The panelists were presented with the frozen ice milk samples for evaluation. Initial testing was performed after one freeze/thaw cycle. Samples that were made from the same batch were also tested after 4 days of freezer storage.

### Raspberry Flavor Rating

Panelists were asked to rate raspberry flavor intensity in the frozen raspberry ice milk on an unscaled line, beginning with 1 and ending with 10. These evaluations were performed on samples frozen for 1 day and again on samples frozen for 4 days. The panelists rated the raspberry flavor encapsulated with various treatments with the following change in values over extended freezer storage. The BCD complexed flavor decreased its flavor intensity rating by 0.74. Initially the flavor rated 6.14 with a change to 5.39 after extended storage. The gum arabic encapsulated flavor decreased its rating by 1.14. The initial flavor intensity rating was 6.07, which decreased to 4.93. The plated control sample decreased its flavor intensity level by 1.64, with an initial rating of 4.85 dropping to 3.21 with extended freezer storage.

The Table below reports the results:

| | | | Change in Flavor |
|---|---|---|---|
| | Flavor Intensity | Flavor Intensity | Intensity Rating |
| | Post One | Post 4 Days | with Extended |
| Treatment | Freeze Thaw | Freeze Storage | Freezer Storage |
| BCD Complexed | 6.14 | 5.39 | 0.75 |
| Flavor | | | |
| Gum Arabic | 6.07 | 4.93 | 1.14 |
| Encapsulated Flavor | | | |
| Plated Flavor | 4.85 | 3.21 | 1.64 |

The results of the initial test show that both beta cyclodextrin and gum arabic provide protection from flavor degradation. The results after 4 days of freezer storage, however, indicate that beta cyclodextrin maintained a higher flavor intensity than flavor encapsulated with gum arabic and continued to have a higher flavor rating than an unprotected flavor. After 4 days of freezer storage, flavor intensity changed the least when complexed with BCD, i.e. 0.75 lower in flavor intensity. The flavor intensity decreased by 1.14 and 1.64 in the samples treated with Gum Arabic and Maltodextrin, respectfully.

### Raspberry Flavor Ranking

The panelists were asked to rank which treatment had the most flavor, second most and least flavor. The flavor complexed ranked first both initially and after 4 days of storage. The percentage of panelists ranking the BCD complexed flavor increased significantly after 4 days of freezer storage. Under the initial condition, the BCD treatment was perceived by 41% of the panelists as having the most raspberry flavor. After 4 days of freezer storage, 58% of the panelists ranked it as having the most raspberry flavor. The gum arabic treated sample decreased in perception of most raspberry flavor over time. These results are illustrated in the Table below.

### Percent of Panelist Ranking Highest in Flavor Intensity

| | | Four |
|---|---|---|
| | One Day Freeze | Days Freezer |
| Treatment | Thaw Cycle | Storage |
| BCD Complexed Flavor | 41% | 58% |
| Gum Arabic Encapsulated Flavor | 35% | 33% |
| Plated Flavor | 24% | 13% |

### Raspberry Flavor Preference

The panelists were asked to identify which sample they preferred. Of the panelists, 53% preferred the sample made with cyclodextrin, 29% of the panelists preferred the sample made with gum arabic, and 18% preferred the sample with the plated flavor.

Comments from the panelists were also recorded and are listed below:

Beta Cyclodextrin Complexed Flavor—fresh raspberry flavor and good balance between raspberry and cream flavor.

Gum Arabic Encapsulated Flavor—chalky, bitter and medicinal off flavor.

Plated flavor—off flavor and medicinal off flavor.

4. Onion Gravy Application—Microwave

The panelists were presented the microwave onion gravy for evaluation of the onion oil complexed with beta cyclodextrin compared to gum arabic encapsulated and oil plated on a maltodextrin as the control.

### Onion Flavor Rating

The panelists were tested in a triangle test and results showed, with at least a 99% confidence, a difference between cyclodextrins complexed flavored samples and the non-protected plated flavor samples. A 95% confidence level that there is a difference between the cyclodextrin encapsulated flavored samples and the gum arabic encapsulated flavored samples. Samples were evaluated for onion flavor intensity. The results, rated on a scale of 1 to 10, with 10 being the highest, showed the onion flavor complexed with beta cyclodextrin was rated at 6.68 compared to the gum arabic sample at 6.10 and 3.69 of the unprotected flavor plated on a maltodextrin. Again, cyclodextrin was shown to protect onion flavor in microwaved food applications with at least a 95% confidence level. These results are the average of the individual results.

### Ranking of Onion Flavor Samples

Using the same procedure as before, the ranking of these samples show that beta cyclodextrins was considered by 52% of the panelists as having the most flavor intensity. The gum arabic samples were considered by 43% of the panelists as having the most flavor. The unprotected flavor was chosen to have the most flavor by 5% of the panelists.

### Preference of Onion Flavor Samples

The results show that onion oil, complexed with cyclodextrins, is better protected than those encapsulated with gum arabic in microwaved food applications and is considered to have a better flavor than flavor encapsulated with gum arabic. The panelists preferences were 43% for BCD, 33% for gum arabic, 14% for maltodextrin and 10% had no preference.

5. Onion Gravy Application—Frozen

The panelists were presented the frozen onion gravy for evaluation of an onion oil complexed with beta cyclodextrin. It was compared to gum arabic encapsulated onion oil and a control of onion oil plated on a maltodextrin. For preparation, the gravy was cooked, frozen, and defrosted slowly, then held on a steam table during the sensory session.

### Onion Flavor Rating

As before, the panelists evaluated the samples in a triangle test that demonstrated, with a 99.9% confidence, that a difference existed between cyclodextrin complexed flavor and the plated flavor. Triangle tested with at least a 95% confidence level indicated there was a difference between the cyclodextrin complex flavor and the gum arabic encapsulated flavor. The panelists were then asked to rate the samples as to onion flavor intensity. The results showed the onion flavor encapsulated with beta cyclodextrin to rate at 6.45 compared to the gum arabic sample at 5.93 and 2.9 of the unprotected flavor plated on a maltodextrin. In this case, after only one day in freezer storage, cyclodextrin was shown to protect onion flavor in frozen food applications, better than onion oil encapsulated by gum arabic or maltodextrin in frozen products.

### Discussion of Results

1. Microwave

In all demonstrated microwaved applications, flavors complexed with cyclodextrin proved to perform better than non encapsulated flavors or microencapsulated flavors with commonly used encapsulants. Cyclodextrin demonstrated the capability to protect flavors via sensory panel results. The panelists always perceived cyclodextrin encapsulated flavors to have a higher flavor intensity level in microwaved food applications even though an equal amount of flavor was used in all tests. This protection is especially observed in the unprotected flavors that are plated onto a maltodextrin. Clearly, unprotected flavors are diminished when exposed to microwave heating. The flavor protection offered by cyclodextrin consistently rates better than traditionally used gum arabic. Flavor chemists believe that the change in flavor during microwave cooking is due to flavor degradation as well as the interaction of other ingredients observed with these cooking conditions. In addition to higher flavor intensity rating, the cyclodextrin complexed flavors were perceived to have a better flavor and lacked an undesirable aftertaste as is seen with the gum arabic and plated samples. This indicated that not only do cyclodextrins prevent flavor degradation, but it may also prevent interactions with other ingredients that may alter the original flavor during the microwave heating process.

2. Frozen Foods

In all demonstrated frozen applications, complexed flavors with cyclodextrins proved to perform better than non encapsulated flavors or microencapsulated flavors with commonly used encapsulants. Cyclodextrin encapsulated flavors demonstrated their capability to protect flavors via sensory panels results. In all cases, the cyclodextrin complexed flavors were perceived to have more flavor and a better flavor than other treatments.

It will be understood that the claims are intended to cover all changes and modifications of the preferred embodiments of the invention herein chosen for the purpose of illustration which do not constitute a departure from the spirit and scope of the invention.

What is claimed is:

1. A method for stabilizing flavors in a prepared food comprising:
encapsulating said flavor with a cyclodextrin;
recovering the encapsulated flavor; and
adding the encapsulated flavor to a food during preparation.

2. The method of claim 1 wherein said cyclodextrin is an alpha, beta or gamma cyclodextrin or a modified alpha, beta or gamma cyclodextrin.

3. The method of claim 1 wherein said food containing said encapsulated flavor is a prepared frozen food.

4. The method of claim 1 wherein said food containing said encapsulated flavor is a prepared microwavable food.

5. The method of claim 1 wherein said flavor is raspberry or onion.

6. A method for stabilizing flavor in a prepared frozen food comprising:
encapsulating a flavor with a cyclodextrin;
recovering the encapsulated flavor; and
adding the encapsulated flavor to a frozen food during preparation.

7. The method of claim 6 wherein said cyclodextrin is an alpha, beta or gamma cyclodextrin or a modified alpha, beta or gamma cyclodextrin.

8. A method for stabilizing flavor in a prepared microwavable food comprising:
encapsulating a flavor with a cyclodextrin;
recovering the encapsulated flavor; and
adding the encapsulated flavor to a microwavable food during preparation.

9. The method of claim 8 wherein said cyclodextrin is an alpha, beta or gamma cyclodextrin or a modified alpha, beta or gamma cyclodextrin.
